(19) United States
(12) Patent Application Publication
(10) Pub. No.: US 2006/0078335 A1
(43) Pub. Date: Apr. 13, 2006

(54) Wireless communication device with infrared transducer

(76) Inventors: Mark Robinson, San Diego, CA (US); Gregory Poilasne, San Diego, CA (US)

Correspondence Address: KYOCERA WIRELESS CORP., P.O. BOX 928289, SAN DIEGO, CA, 92192-8289, US

(21) Appl. No.: 10/964,843

(22) Filed: Oct. 13, 2004

(51) Int. Cl. H04B 10/00

(52) U.S. Cl. 398/117

(57) ABSTRACT

A wireless communication device is provided having an infrared transducer integrated on certain components. If the wireless communication device has an external antenna, the infrared transducer may be positioned at the tip of the antenna; if the wireless communication device has a clam-shell construction, the infrared transducer may be positioned within the hinge structure. In either position, the infrared transducer can establish line-of-sight connectivity and fill a space previously considered unusable for functional components.

### CROSS REFERENCE TO RELATED APPLICATIONS

Not applicable.

### STATEMENT REGARDING FEDERALLY SPONSORED RESEARCH AND DEVELOPMENT

Not applicable.

### REFERENCE TO A COMPUTER LISTING, A TABLE, OR A COMPUTER PROGRAM LISTING COMPACT DISK APPENDIX

Not applicable.

### BACKGROUND

1. Field

The present invention relates generally to the field of wireless communication devices, and, more particularly, to a wireless mobile handset having an infrared transducer.

2. Description of Related Art

Wireless communication devices are becoming increasingly complex due to the integration of different functionalities within the devices. For example, wireless mobile handsets today cannot only receive and transmit voice signals, but can also connect to the internet, send and receive e-mail, and perform certain computational functions originally performed only by computers. As another example, personal digital assistants today can not only perform certain basic scheduling and computational functions, but can also transmit and receive data and voice signals and, in certain instances, connect to WiFi systems.

At the same time, wireless communication devices are continuously undergoing a miniaturization process, in order to increase portability and fit different lifestyles. Therefore, designers and manufacturers of wireless communication devices are continuously confronted with the opposing requirements of adding functionalities while reducing size.

Infrared communication has recently been added to the functional capabilities of wireless communication devices, in order to provide line-of-sight communication not only with other wireless devices, but also with office appliances such as palm handhelds, personal computers, printers, and various types of peripherals. Therefore, the designer must integrate an infrared transducer and the related electrical circuitry within the very severe space constraints of a wireless communication device while still maintaining line-of-sight connection. This is particularly challenging considering the different modes of use of a wireless communication device, for instance, in the hand of a user, laid flat on a support surface, or lodged in a cradle holder.

U.S. Pat. No. 5,636,264 to Sulavouri et al. discloses a radio telephone system, which utilizes an infrared communication link and which comprises a transceiver unit and an external device. This invention, however, does not teach the positioning of the infrared transducer within the severe space limitations of a radio telephone housing and in a way that will still enable line-of-sight connectivity. Additionally, this invention does not disclose how to integrate the infrared transducer within any specific components of the radio telephone.

A need therefore exists to integrate an infrared transducer on a wireless communication device having very limited housing space. A further need exists to position the infrared transducer on the wireless communication device so to have an unobstructed line of sight and optimized infrared communication capabilities.

### SUMMARY

A wireless communication device is provided having an infrared transducer that is integrated with an antenna or hinge structure, so to fill a portion of space previously considered unusable for functional accessories and to enable line-of-sight connectivity for the infrared transducer.

In one example, the infrared transducer is positioned in an external antenna, which may be either of fixed, “stub” design or of retractable, “whip” design. The resulting antenna system comprises a casing having a proximal end mounted to the device and a distal end extending from the device; an infrared transducer located at the distal end of the casing and connected to an infrared signal circuitry; a plurality of conduits for electrically connecting the infrared transducer to the infrared signal circuitry; and an RF radiator connected to a radio frequency signal circuitry and radiating radio frequency signals.

In another example, a wireless device is provided in a hinged “clam-shell” or folded construction. The infrared transducer is positioned in the hinge system. The resulting hinge system comprises a first hinge member at the main body of the device; an infrared transducer situated on the first hinge member and connected to an infrared signal circuitry; a plurality of conduits extending from the infrared transducer within the first hinge member; and a second hinge member at the fold of the device to enable a relative rotation between the hinge members.

These and other features of the present invention will become apparent from a reading of the following description, and may be realized by means of the instrumentalities and combinations particularly pointed out in the appended claims.

### BRIEF DESCRIPTION OF THE SEVERAL VIEWS OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a perspective view illustrating a wireless mobile handset in accordance with the present invention.

FIGS. 2A and 2B are cross-sectional views showing detailed variations of the wireless mobile handset of FIG. 1.

FIG. 3 is a perspective view illustrating another wireless mobile handset in accordance with the present invention.

FIGS. 4A and 4B are cross-sectional views showing detailed variations of the wireless mobile handset of FIG. 3.

FIG. 5 is a perspective view illustrating yet another wireless mobile handset in accordance with the present invention.

### DETAILED DESCRIPTION OF THE INVENTION

Detailed descriptions of examples of the invention are provided herein. It is to be understood, however, that the present invention may be exemplified in various forms. Therefore, the specific details disclosed herein are not to be interpreted as limiting, but rather as a representative basis for teaching one skilled in the art how to employ the present invention in virtually any detailed system, structure, or manner.

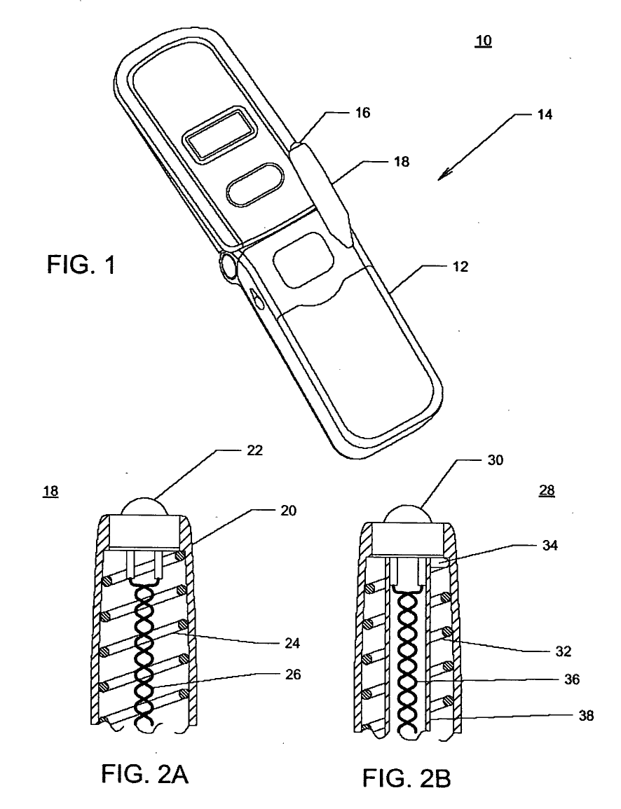

Referring now to FIG. 1, a wireless communication device is illustrated as a wireless mobile handset 10, but it will be appreciated that the present description is equally applicable to other types of wireless communication devices. Wireless mobile handset 10 comprises a housing 12 holding a circuit board (not shown) and an antenna system 14 that has a fixed configuration, otherwise known as a “stub” configuration. The circuit board includes circuitry for generating and receiving both infrared signals and radio frequency signals. Because the designs of infrared and radio frequency circuitries are known in the art, the circuit board will not be described in detail here.

The operation of antenna system 14 may be understood upon reference to FIG. 2A. Stub antenna 18 generally comprises a casing 20 and an infrared transducer 22. The infrared transducer 22 may typically be implemented as an infrared emitting diode, and is electrically connected to the infrared signal circuitry. In this way the infrared transducer 22 is enabled to radiate and receive infrared signals. The antenna system 14 also has an RF radiator, which in the illustrated example is a coil 24. The coil 24 may typically of helical shape, and is electrically connected to the radio frequency signal circuitry to enable the radiating and receiving of radio frequency signals. A plurality of conduits 26, typically electrical wires, extend through coil 24 and connect the infrared transducer 22 to the infrared signal circuitry. In the illustrated example, infrared transducer 22 is situated at that end of stub antenna system 18 which is at the greatest distance from the housing of the wireless communication device. This arrangement enables a sufficiently wide and unobstructed line-of-sight during transmission and reception of infrared signals; however, it will be appreciated that other positions on stub 18 may be possible. Further, conduits 26 are typically wound together, in order to minimize cross-talk interference with coil 24. Alternatively, the conduits may be constructed as a co-axial line. Although the RF radiating structure for antenna 18 is illustrated as a coil 24, it will be understood that other RF radiators may be used. For example, a printed meander-line may be disposed on a flexible material, which in turn is wrapped or positioned around a support element. The support element may be constructed as a plastic cone or cylinder, for example, and may be electrically or capacitively coupled to the radio frequency signal source.

Turning now to FIG. 2B, there are shown possible variations of the antenna system. In addition to an infrared transducer 30, a stub antenna 28 may comprise a coil for radiating radio frequency signals that includes both a helical radiating element 30 and a linear radiating element 32, with linear radiating element 32 being in direct electrical contact with, and extending through, helical radiating element 30. Further, stub antenna 28 may comprise conduits that are both wound together and electrically shielded, for instance, by the addition of an insulating sheathing 38, in order to further reduce cross-talk interference.

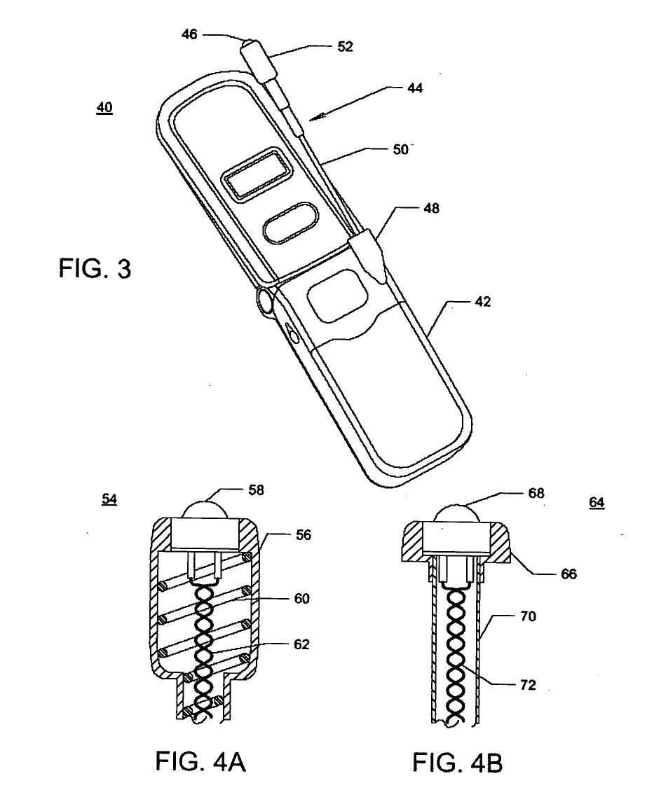

Referring now to FIG. 3, another wireless communication device is shown as a wireless mobile handset 40, but it will be appreciated that the present description is equally applicable to other types of wireless communication devices. Wireless mobile handset 40 comprises a housing 42 holding a circuit board (not shown) and a retractable antenna system 44 having an extensible or “whip” design. The circuit board includes circuitry for generating and receiving both infrared and radio frequency signals. Instead, antenna system 44 comprises a base portion 48, mounted on housing 42; a lower retractable portion or “straw” 50; and an upper retractable portion or “tip” 52. Further, antenna system 42 includes a radio frequency antenna for radiating radio frequency signals and an infrared transducer for radiating infrared signals.

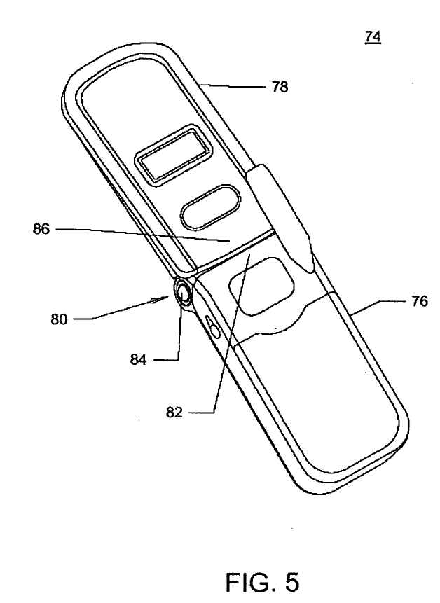

The operation of whip antenna 44 may be understood upon reference to FIG. 4A. Tip 54 comprises an infrared transducer 58, typically an infrared emitting diode, that is electrically connected to an infrared signal circuitry and that radiates infrared signals. A casing 56 holds infrared transducer 58 and also encloses a coil 60, typically of helical design, that is electrically connected to a radio frequency signal circuitry and that radiates radio frequency signals. A plurality of conduits 62, typically electrical wires, electrically connect infrared transducer 58 to the infrared signal circuitry. Infrared transducer 58 is typically situated at that end of tip 54 which is at the greatest distance from the housing of the wireless communication device, to enable a sufficiently wide and unobstructed line of sight during transmission and reception of infrared signals. Further, conduits 62 are typically wound together, both to avoid a cupping effect when the straw is retracted, and to minimize cross-talk interferences between coil 60 and conduits 62. Alternatively, the conduits may be constructed using a coaxial line.

Turning now to FIG. 4B, there is shown a variation of the whip antenna system, wherein the radio frequency radiating coil is situated in the base portion of the retractable antenna system rather than in the tip. In this configuration, a tip 64 comprises a casing 66 that contains an infrared transducer 68, typically an infrared emitting diode. Tip 64 is connected to straw 70, which is hollow and which provides a passageway for conduits 72 connecting infrared transducer 68 to the infrared signal circuitry. Even in this configuration, conduits 72 are typically wound together, in order to minimize cross-talk interference. Alternatively, the conduits may be constructed using a coaxial line.

Some wireless communication devices are designed to be foldable, in order to protect the display screen and the keys of the devices, and to provide more compact packages. For example, some wireless mobile handsets have “clam-shell” housings that comprise a first part, or main body; a second part, or fold; and a hinge connecting the main body with the fold. This arrangement enables the main body and fold to rotate in relation to each other between an open position and a closed position. Additionally, the hinge structure allows the passage of electrical conduits, enabling the transmission of electrical signals between the main body and the fold. Because the design of clam-shell handsets is known in the art, the hinge structure will not be described in detail here.

FIG. 5 illustrates still another wireless communication device, shown as a wireless mobile handset 74. Handset 74 generally comprises a main body 76; a fold 78; and a hinge system 80 rotatably connecting the main body 76 to the fold 78. More specifically, hinge system 80 comprises a first hinge member arranged as a fixed member 82. The fixed member 82 is provided at main body 76, and includes an infrared transducer 84 (typically an infrared emitting diode) in an external opening of fixed member 82. A second hinge member is arranged as rotary member 86, which is provided at fold 78 and connected to fixed member 82. In one construction of the hinge, one or more shafts (not shown in detail) may be used to connect the rotary member 86 to the fixed member 82 by extending through predetermined portions of fixed member 82 and of rotary member 86. A plurality of conduits (also not shown in detail) connects infrared transducer 84 to an infrared signal circuitry.

It will be appreciated that alternative constructions of the hinge system are possible, and that the position of the infrared transducer may be adjusted to fit the selected design alternative. In one design, the one or more shafts may be entirely enclosed within the hinge system and, therefore, may not be visible to an outside observer. In this configuration, the plurality of conduits extends through a cavity in the fixed member and may or may not extend through a cavity in the one or more shafts.

In another design, the one or more shafts extend to the outer surface of the fixed member, becoming visible to an outside observer. In such a configuration, the infrared transducer may be positioned in a cavity within one of the one or more shafts, and the plurality of conduits may extend at least partially within an inner passageway of the one or more shafts.

While the invention has been described in connection with a number of embodiments, it is not intended to limit the scope of the invention to the particular forms set forth, but on the contrary, it is intended to cover such alternatives, modifications, and equivalents as may be included within the scope of the invention.

What is claimed is:

1. An antenna system for a wireless communication device comprising:
a casing having a proximal end mounted to the wireless communication device and a distal end extending from the wireless communication device;
an infrared transducer for radiating infrared signals, the infrared transducer being located at the distal end of the casing and being electrically connected to an infrared signal circuitry;
a plurality of conduits for electrically connecting the infrared transducer to the infrared signal circuitry; and
an RF radiator for radiating radio frequency signals, the RF radiator being located inside the casing and being coupled to a radio frequency signal circuitry.

2. The antenna system for a wireless communication device of claim 1, wherein the infrared transducer is an infrared emitting diode.

3. The antenna system for a wireless communication device of claim 1, wherein the plurality of electrical conduits are wound together.

4. The antenna system for a wireless communication device of claim 1, wherein the RF radiator comprises a helical radiating element located inside the casing and is electrically connected to the radio frequency signal circuitry.

5. The antenna system for a wireless communication device of claim 4, further comprising a linear radiating element in direct electrical contact with the helical radiating element and extending into the helical radiating element.

6. The antenna system for a wireless communication device of claim 1, wherein the plurality of conduits are electrically shielded from the RF radiator.

7. An antenna system for a wireless communication device comprising:
a casing having a proximal end mounted to the wireless communication device and a distal end extending from the wireless communication device;
an infrared emitting diode situated at the distal end of the casing and electrically connected to an infrared signal circuitry;
an RF radiator for radiating radio frequency signals, the RF radiator being coupled to a radio frequency signal circuitry and comprising a helical radiating element and a linear radiating element in direct electrical contact, the linear radiating element extending into the helical radiating element; and
a plurality of conduits extending from the infrared emitting diode through the RF radiator and electrically connecting the infrared emitting diode to a source of infrared energy,
wherein the plurality of electrical conduits are wound together and are electrically shielded from the RF radiator.

8. A wireless communication device comprising:
a housing;
a circuit board contained in the housing and including a source of infrared energy and a source of radio frequency energy; and
an antenna system for radiating infrared and radio frequency signals, the antenna system being mounted to the housing and comprising,
an infrared transducer;
a plurality of conduits that electrically connect the infrared transducer to the circuit board, and
an RF radiator for radiating radio frequency signals that is coupled to the circuit board.

9. The wireless communication device of claim 8, wherein the infrared transducer is an infrared emitting diode.

10. The wireless communication device of claim 8, wherein the wireless communication device is a cellular telephone.

11. The wireless communication device of claim 8, wherein the antenna system is located in a columnar casing of constant length extending from the housing.

12. The wireless communication device of claim 8, wherein the antenna system has a retracted position and an extended position relative to the housing, and wherein the antenna system comprises:
a base portion mounted to the housing; and
a retractable portion extending from the housing and having an inner cavity,
wherein the RF radiator and the infrared transducer are located in the retractable portion, and wherein the plurality of conduits extend along the inner cavity.

13. The wireless communication device of claim 8, wherein the antenna system has a retracted position and an extended position relative to the housing, and wherein the antenna system comprises:
a base portion mounted to the housing; and
a retractable portion extending from the housing and having an inner cavity,
wherein the RF radiator is located in the base portion, the infrared transducer is located in the retractable portion, and the plurality of conduits extend along the inner cavity.

14. The wireless communication device of claim 8, wherein the RF radiator comprises a coil.

15. The wireless communication device of claim 8, wherein the RF radiator comprises a meanderline.

16. A hinge system for connecting a main body and a fold of a wireless communication device comprising:
a first hinge member provided at the main body and having an external opening connected to an internal cavity;
an infrared transducer for radiating infrared signals, the infrared transducer being situated in the external opening and being electrically connected to an infrared signal circuitry;
a plurality of conduits connecting the infrared transducer to the infrared signal circuitry and extending along the internal cavity; and
a second hinge member provided at the fold and rotatably connected to the first hinge member.

17. The hinge system of claim 16, wherein the infrared transducer is an infrared emitting diode.

18. The hinge system of claim 16, wherein:
at least one shaft extends through the interior cavity and to the external opening, and has an inner passageway;
the infrared transducer is situated at one end of the shaft; and
the plurality of conduits extend through the inner passageway.

19. A wireless communication device comprising:
a main body;
a fold; and
a hinge system rotatably connecting the main body to the fold and comprising,
a fixed member provided at the main body and having an external opening connected to an internal cavity;
an infrared transducer for radiating infrared signals, the infrared transducer being situated in the external opening and being electrically connected to an infrared signal circuitry;
a plurality of conduits connecting the infrared transducer to the infrared signal circuitry and extending along the internal cavity;
a rotary member provided at the fold and rotatably connected to the fixed member; and
at least one shaft connecting the rotary member to the fixed member and extending through predetermined portions of the rotary member and of the fixed member.

20. The wireless communication device of claim 19, wherein the infrared transducer is an infrared emitting diode.

21. The wireless communication device of claim 19, wherein:
the shaft extends through the interior cavity and to the external opening, and has an inner passageway;
the infrared transducer is situated at one end of the at least one shaft; and
the plurality of conduits extends through the inner passageway.

22. The wireless communication device of claim 19, wherein the wireless communication device is a cellular telephone.
